(19) United States
(12) Patent Application Publication
(10) Pub. No.: US 2023/0100366 A1
(43) Pub. Date: Mar. 30, 2023

(54) SIGNALING DETAILS OF NETWORK CODED TRANSMISSIONS

(71) Applicant: QUALCOMM Incorporated, San Diego, CA (US)

(72) Inventors: Gabi Sarkis, San Diego, CA (US); Guangyl Liu, San Diego, CA (US); Hong Cheng, Basking Ridge, NJ (US)

(21) Appl. No.: 17/485,072

(22) Filed: Sep. 24, 2021

(51) Int. Cl. H04L 1/00; H04L 5/00; H04L 1/18

(52) U.S. Cl. CPC H04L 1/0009; H04L 5/0053; H04L 1/1867; H04W 76/14

(57) ABSTRACT

Methods, systems, and devices for wireless communication are described. A network entity (e.g., a roadside unit, a relay node, a user equipment (UE), or a base station) may use a network coding indication in a transmission that indicates the transmission is a network coded transmission (i.e., the transmission includes retransmitted packets from UEs in a wireless communications system). The indication may be explicitly or implicitly signaled in control information. For example, control information may include a field that explicitly identifies the network coded transmission. Additionally or alternatively, the control information may implicitly identify the network coded transmission, such as by indicating a format of control signaling or including a special source identifier in the network coded transmission. The network coded transmission may also include one or more network coding parameters that identify parameters of the original transmission.

### FIELD OF TECHNOLOGY

The following relates to wireless communication, including signaling details of network coded transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, UEs may communicate directly with one another via sidelink connections. In some cases, however, existing sidelink communication techniques may be deficient.

### SUMMARY

The described techniques relate to improved methods, systems, devices, and apparatuses that support signaling details of network coded transmissions. Generally, the described techniques provide for enabling a network entity (e.g., a roadside unit (RSU), a relay node, a user equipment (UE), or a base station) to use a network coding indication in a transmission that indicates the transmission is a network coded transmission (i.e., the transmission includes retransmissions from UEs in a sidelink communications system). The indication may be explicitly or implicitly signaled in control information. For example, control information may include a field that explicitly identifies the network coded transmission. Additionally or alternatively, the control information may implicitly identify the network coded transmission, such as by indicating a format of control signaling or including a special source identifier in the network coded transmission. The network coded transmission may also include one or more network coding parameters that identify parameters of an original transmission.

A method for wireless communication at a first device is described. The method may include receiving, from a second device via a sidelink connection, a first transmission that includes an indication that the first transmission is to be encoded at the first device for retransmissions and transmitting, via the sidelink connection to a third device, a second transmission that is encoded based on the indication, the second transmission including at least the first transmission.

An apparatus for wireless communication at a first device is described. The apparatus may include a processor, memory coupled with the processor, and instructions stored in the memory. The instructions may be executable by the processor to cause the apparatus to receive, from a second device via a sidelink connection, a first transmission that includes an indication that the first transmission is to be encoded at the first device for retransmissions and transmit, via the sidelink connection to a third device, a second transmission that is encoded based on the indication, the second transmission including at least the first transmission.

Another apparatus for wireless communication at a first device is described. The apparatus may include means for receiving, from a second device via a sidelink connection, a first transmission that includes an indication that the first transmission is to be encoded at the first device for retransmissions and means for transmitting, via the sidelink connection to a third device, a second transmission that is encoded based on the indication, the second transmission including at least the first transmission.

A non-transitory computer-readable medium storing code for wireless communication at a first device is described. The code may include instructions executable by a processor to receive, from a second device via a sidelink connection, a first transmission that includes an indication that the first transmission is to be encoded at the first device for retransmissions and transmit, via the sidelink connection to a third device, a second transmission that is encoded based on the indication, the second transmission including at least the first transmission.

Some examples of the method, apparatuses, and non-transitory computer-readable medium described herein may further include operations, features, means, or instructions for transmitting, in response to receiving the first transmission, an encoding indication in a sidelink control information message, a medium access control (MAC) header, a media access control (MAC) sub-header, or any combination thereof, where the second transmission may be encoded further based on the encoding indication.

Some examples of the method, apparatuses, and non-transitory computer-readable medium described herein may further include operations, features, means, or instructions for transmitting, in a first sidelink control information message, a format indication for a second sidelink control information message, where the second transmission may be encoded further based on the format indication.

Some examples of the method, apparatuses, and non-transitory computer-readable medium described herein may further include operations, features, means, or instructions for transmitting signaling including a source identifier, where the second transmission may be encoded further based on the source identifier.

In some examples of the method, apparatuses, and non-transitory computer-readable medium described herein, the source identifier includes a device identifier associated with the wireless device.

In some examples of the method, apparatuses, and non-transitory computer-readable medium described herein, the second transmission identifies a set of one or more transmissions encoded in the second transmission, the set of one or more transmissions including the first transmission.

In some examples of the method, apparatuses, and non-transitory computer-readable medium described herein, the second transmission identifies a first identifier and a second identifier associated with the first transmission, the first identifier corresponding to the second device and the second identifier corresponding to the third device.

In some examples of the method, apparatuses, and non-transitory computer-readable medium described herein, the second transmission includes a first set of one or more bits associated with the first identifier and a second set of one or more bits associated with the second identifier.

In some examples of the method, apparatuses, and non-transitory computer-readable medium described herein, the first set of one or more bits and the second set of one or more bits may be included in a sidelink control information message associated with the first transmissions.

In some examples of the method, apparatuses, and non-transitory computer-readable medium described herein, the second transmission identifies one or more transmission parameters associated with the first transmission.

In some examples of the method, apparatuses, and non-transitory computer-readable medium described herein, the one or more transmission parameters include a cast type, a feedback type, a hybrid automatic repeat request identifier, a location of the first user equipment (UE), a communication range, a slot index, an index relative to the second transmission, a transport block cyclic redundancy check value, a transport block size, or any combination thereof.

In some examples of the method, apparatuses, and non-transitory computer-readable medium described herein, the one or more transmission parameters may be included in a sidelink control information message associated with the first transmission.

In some examples of the method, apparatuses, and non-transitory computer-readable medium described herein, the first device includes a roadside unit, a relay node, a user equipment, a base station, or any combination thereof.

A method for wireless communication at a first device is described. The method may include monitoring for a first transmission from a second device via a sidelink connection, receiving, from a third device, an encoding indication associated with the first transmission, receiving a second transmission from a third device, and decoding the second transmission based on the encoding indication to obtain the first transmission.

An apparatus for wireless communication at a first device is described. The apparatus may include a processor, memory coupled with the processor, and instructions stored in the memory. The instructions may be executable by the processor to cause the apparatus to monitor for a first transmission from a second device via a sidelink connection, receive, from a third device, an encoding indication associated with the first transmission, receive a second transmission from a third device, and decode the second transmission based on the encoding indication to obtain the first transmission.

Another apparatus for wireless communication at a first device is described. The apparatus may include means for monitoring for a first transmission from a second device via a sidelink connection, means for receiving, from a third device, an encoding indication associated with the first transmission, means for receiving a second transmission from a third device, and means for decoding the second transmission based on the encoding indication to obtain the first transmission.

A non-transitory computer-readable medium storing code for wireless communication at a first device is described. The code may include instructions executable by a processor to monitor for a first transmission from a second device via a sidelink connection, receive, from a third device, an encoding indication associated with the first transmission, receive a second transmission from a third device, and decode the second transmission based on the encoding indication to obtain the first transmission.

In some examples of the method, apparatuses, and non-transitory computer-readable medium described herein, receiving the encoding indication may include operations, features, means, or instructions for receiving the encoding indication in a sidelink control information message, a medium access control (MAC) header, a MAC sub-header, or any combination thereof.

In some examples of the method, apparatuses, and non-transitory computer-readable medium described herein, receiving the encoding indication may include operations, features, means, or instructions for receiving, in a first sidelink control information message, a format indication for a second sidelink control information message, where the format indication includes the encoding indication.

In some examples of the method, apparatuses, and non-transitory computer-readable medium described herein, receiving the encoding indication may include operations, features, means, or instructions for receiving signaling including a source identifier, where the source identifier includes the encoding indication.

In some examples of the method, apparatuses, and non-transitory computer-readable medium described herein, the source identifier includes a device identifier associated with the wireless device.

In some examples of the method, apparatuses, and non-transitory computer-readable medium described herein, the second transmission identifies a set of one or more transmissions encoded in the second transmission, the set of one or more transmissions including the first transmission.

In some examples of the method, apparatuses, and non-transitory computer-readable medium described herein, the second transmission identifies a first identifier and a second identifier associated with the first transmission, the first identifier corresponding to the first device and the second identifier corresponding to the second device.

In some examples of the method, apparatuses, and non-transitory computer-readable medium described herein, the second transmission includes a first set of one or more bits associated with the first identifier and a second set of one or more bits associated with the second identifier.

In some examples of the method, apparatuses, and non-transitory computer-readable medium described herein, the first set of one or more bits and the second set of one or more bits may be included in a sidelink control information message associated with the first transmission.

In some examples of the method, apparatuses, and non-transitory computer-readable medium described herein, the second transmission identifies one or more transmission parameters associated with the first transmission.

In some examples of the method, apparatuses, and non-transitory computer-readable medium described herein, the one or more transmission parameters include a cast type, a feedback type, a hybrid automatic repeat request identifier, a location of the second UE, a communication range, a slot index, an index relative to the second transmission, a transport block cyclic redundancy check value, a transport block size, or any combination thereof.

In some examples of the method, apparatuses, and non-transitory computer-readable medium described herein, the one or more transmission parameters may be included in a sidelink control information message associated with the first transmission.

In some examples of the method, apparatuses, and non-transitory computer-readable medium described herein, the third device includes a roadside unit, a relay node, a user equipment, a base station, or any combination thereof.

### BRIEF DESCRIPTION OF THE DRAWINGS

FIG. 1 illustrates an example of a wireless communications system that supports signaling details of network coded transmissions in accordance with aspects of the present disclosure.

FIG. 2 illustrates an example of a wireless communications system that supports signaling details of network coded transmissions in accordance with aspects of the present disclosure.

FIG. 3 illustrates an example of a process flow that supports signaling details of network coded transmissions in accordance with aspects of the present disclosure.

FIGS. 4 and 5 show block diagrams of devices that support signaling details of network coded transmissions in accordance with aspects of the present disclosure.

FIG. 6 shows a block diagram of a communications manager that supports signaling details of network coded transmissions in accordance with aspects of the present disclosure.

FIG. 7 shows a diagram of a system including a device that supports signaling details of network coded transmissions in accordance with aspects of the present disclosure.

FIGS. 8 and 9 show block diagrams of devices that support signaling details of network coded transmissions in accordance with aspects of the present disclosure.

FIG. 10 shows a block diagram of a communications manager that supports signaling details of network coded transmissions in accordance with aspects of the present disclosure.

FIG. 11 shows a diagram of a system including a device that supports signaling details of network coded transmissions in accordance with aspects of the present disclosure.

FIGS. 12 and 13 show flowcharts illustrating methods that support signaling details of network coded transmissions in accordance with aspects of the present disclosure.

### DETAILED DESCRIPTION

In sidelink communications, such as in vehicle-to-everything (V2X) systems, a source user equipment (UE) may broadcast transmissions to multiple destination UEs. In some cases, one or more destination UEs may fail to receive the broadcasted transmissions, and request a retransmission. In some cases, however, such as when the sidelink system includes a relatively large quantity of UEs, or when a geographic footprint of the sidelink system is relatively large, retransmission requests and associated retransmissions may consume a significant portion of transmission resources in the sidelink system. In some examples, the sidelink system may include a network entity (e.g., a roadside unit (RSU), a relay node, a designated UE, or a base station), which may be referred to as a network coding device, that is responsible for retransmitting transmissions in a network coded transmission. It may be beneficial to establish which information to signal in the network coded transmission to enable a destination UE to decode a network coded transmission to obtain the retransmitted transmission.

According to the techniques described herein, a network entity may use a network coding indication in a transmission that indicates the transmission is a network coded transmission (i.e., the transmission includes retransmissions from UEs in a wireless communications system). The indication may be explicitly or implicitly signaled in control information. For example, control information may include a field that explicitly identifies the network coded transmission. Additionally or alternatively, the control information may implicitly identify the network coded transmission, such as by indicating a format of control signaling or including a special source identifier in the network coded transmission. The network coded transmission may also include one or more network coding parameters that identify parameters of the original transmission.

Aspects of the disclosure are initially described in the context of wireless communications systems. Aspects of the disclosure are further illustrated by and described with reference to a process flow, apparatus diagrams, system diagrams, and flowcharts that relate to signaling details of network coded transmissions.

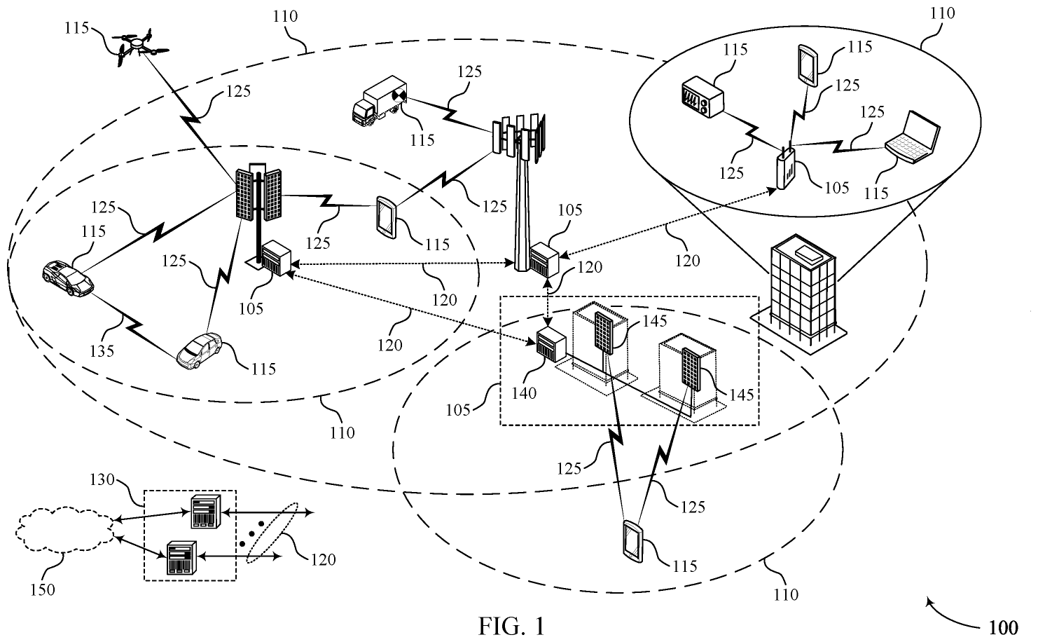

FIG. 1 illustrates an example of a wireless communications system 100 that supports signaling details of network coded transmissions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Δfₘₐₓ may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using V2X communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

According to the techniques described herein, a network entity (e.g., an RSU, a relay node, a UE 115, or a base station 105) may use a network coding indication in a transmission that indicates the transmission is a network coded transmission (i.e., the transmission includes retransmissions from UEs 115 in the wireless communications system 100). The indication may be explicitly or implicitly signaled in control information. For example, control information may include a field that explicitly identifies the network coded transmission. Additionally or alternatively, the control information may implicitly identify the network coded transmission, such as by indicating a format of control signaling or including a special source identifier in the network coded transmission. The network coded transmission may also include one or more network coding parameters that identify parameters of the original transmission.

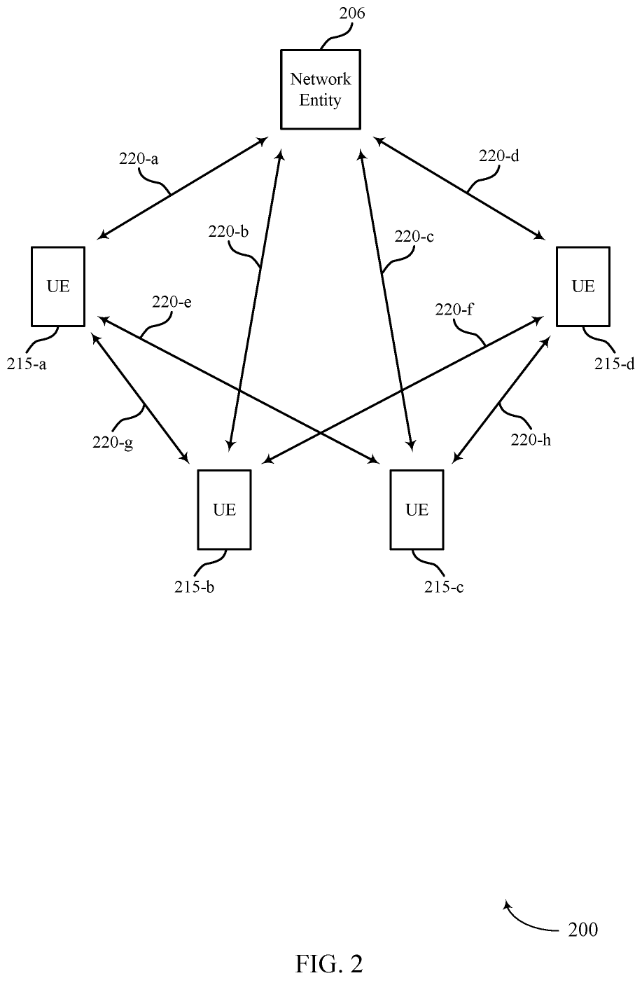

FIG. 2 illustrates an example of a wireless communications system 200 that supports signaling details of network coded transmissions in accordance with aspects of the present disclosure. In some examples, the wireless communications system 200 may implement aspects of the wireless communication system 100. For example, the wireless communications system 200 may include a network entity 206 and UEs 215, which may be examples of the corresponding devices described with reference to FIG. 1. In some examples, the wireless communications system 200 may be a V2X system, where each of the UEs 215 and the network entity 206 may be an RSU, a relay node, or a vehicle. For example, the network entity may be a designated vehicle associated with the vehicles in the set of UEs 215.

The wireless communications system 200 may support sidelink communications between the UEs 215 via sidelink channels 220. For example, a UE 215-a may transmit a transmission (e.g., including one or more transport blocks (TBs)) to UEs 215-b and UE 215-c via sidelink channels 220-e and 220-g. In some examples, the UE 215-a may be referred to as a source UE 215 for the transmission and the UEs 215-b and UE 215-c may be referred to as destination UEs for the transmission. In some cases, such as when the wireless communications system 200 includes a relatively large quantity of UEs 215, or when a geographic footprint of the wireless communications system 200 is relatively large, retransmission requests and associated retransmissions may consume a significant portion of transmission resources on the sidelink channels 220.

According to the techniques described herein, the UE 215-a may transmit the transmission to the network entity 206. The transmission may include a coding flag, which may indicate the network entity 206 is to retransmit the data of the transmission in a network coded transmission as requested by a UE 215. In some cases, one or more UEs 215, such as the UE 215-c, may transmit a request for retransmission of the data. For example, the UE 215-c may transmit a negative acknowledgment (NACK) indicating the UE 215-c failed to receive or decode the transmission. Based on the request, the network entity 206 may encode the transmission in a network coded transmission. The network coded transmission may include a set of transmissions requested for retransmission. In some examples, the network entity 206 may combine packets of the set of transmissions (e.g., using an exclusive-or (XOR) operation) to form a parity packet in the network coded transmission.

The network entity 206 may transmit an indication (e.g., an encoding indication) of the network coded transmission via sidelink channels 220 to the UEs 215. In some examples, the indication may be an explicit indication, for example in a field of control signaling, such as a sidelink control information (SCI) message (e.g., an SCI-1 or SCI-2 message), or in a MAC header or sub-header of the network coded transmission. In some examples, the indication may be an implicit indication. For example, the network entity 206 may indicate an SCI-2 format in an SCI-2 format indicator field in an SCI-1 message. The SCI-2 format may indicate that a transmission from the network entity 206 is the network coded transmission. Additionally or alternatively, the network entity 206 may include a source identifier in the network coded transmission. For example, the source identifier may be a device identifier associated with the network entity 206. The network entity 206 may indicate to the UEs 215 in a prior transmission that the device identifier is associated with network coded transmissions.

In some examples, the network entity 206 may include one or more network coding parameters in the network coded transmission to identify the transmissions requested for retransmission in the network coded transmission. In some examples, the network entity 206 may signal the one or more network coding parameters to the UEs 215 using an SCI-2 format, a MAC control element (MAC-CE), a MAC header or sub-header, an RRC message, or any combination thereof.

In some examples, the network coded transmission may indicate a quantity of transmissions encoded in the network coded transmission. Additionally or alternatively, the network coded transmission may indicate a respective source identifier and destination identifier for each transmission. The identifiers may be the complete identifiers, or a subset of bits associated with each identifier (e.g., a subset of bits included in an SCI-2 message). Additionally or alternatively, the network coded transmission may indicate a cast type (e.g., broadcast, multi-cast, or unicast) of each transmission, a feedback type (e.g., HARQ acknowledgment (ACK) feedback) of each transmission, a HARQ identifier of each transmission, or any combination thereof. In some examples, the network coded transmission may indicate a location of the source UE 215 of the transmission, a communication range of the transmission, or both (e.g., as signaled in SCI-2). Additionally or alternatively, the network coded transmission may indicate a respective slot index in which each transmission was received at the network entity 206, such as an index relative to the network coded transmission. Additionally or alternatively, the network coded transmission may indicate a respective TB CRC, TB size, or both, of each transmission.

The network entity 206 may transmit the network coded transmission to the UEs 215 via the sidelink channels 220. Based on the encoding indication, each UE 215 may identify the network coded transmission and decode the transmissions requested for retransmission. For example, the UE 215-c may receive the network coded transmission, identify the transmission from the UE 215-a based on the one or more network coding parameters, and decode the transmission. The operations performed by the network entity 206 and the UEs 215 may support improvements to sidelink communications in the wireless communications system 200, among other benefits.

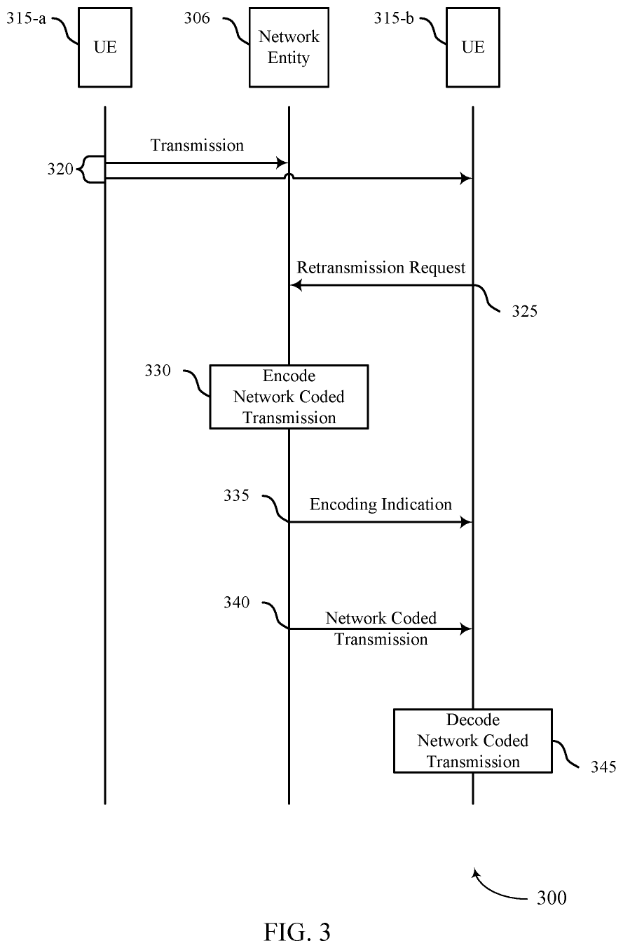

FIG. 3 illustrates an example of a process flow 300 that supports signaling details of network coded transmissions in accordance with aspects of the present disclosure. In some examples, the process flow 300 may implement aspects of wireless communications systems 100 and 200. For example, the process flow 300 may include example operations associated with one or more of a network entity 306 or a UE 315, which may be examples of the corresponding devices described with reference to FIGS. 1 and 2. In the following description of the process flow 300, the operations between the network entity 306 and the UEs 315 may be performed in a different order than the example order shown, or the operations performed by the network entity 306 and the UEs 315 may be performed in different orders or at different times. Some operations may also be omitted from the process flow 300, and other operations may be added to the process flow 300. The operations performed by the network entity 306 and the UEs 315 may support improvement to the UE 315 sidelink operations and, in some examples, may promote improvements to communications reliability for the network entity 306 and the UEs 315, among other benefits.

At 320, a UE 315-a may transmit a transmission (e.g., including one or more TBs) to the network entity 306 and the UE 315-b. The transmission may include a coding flag, which may indicate the network entity 306 is to retransmit the transmission in a network coded transmission as requested by another UE 315, such as the UE 315-b. At 325, the UE 315-b may transmit a request for retransmission. For example, the UE 315-b may transmit a NACK indicating the UE 315-b failed to receive or decode the transmission.

At 330, the network entity 306 may encode the transmission in a network coded transmission, for example based on the request from the UE 315-b. The network coded transmission may include a set of transmissions requested for retransmission. In some examples, the network entity 306 may combine packets of the set of transmissions (e.g., using an XOR operation) to form a parity packet in the network coded transmission. In some examples, the network entity 306 may include one or more network coding parameters in the network coded transmission to identify the transmissions requested for retransmission in the network coded transmission. In some examples, the network entity 306 may signal the one or more network coding parameters to the UEs 315 using an SCI-2 format, a MAC-CE, a MAC header or sub-header, an RRC message, or any combination thereof.

In some examples, the network coded transmission may indicate a quantity of transmissions encoded in the network coded transmission. Additionally or alternatively, the network coded transmission may indicate a respective source identifier and destination identifier for each transmission. The identifiers may be the complete identifiers, or a subset of bits associated with each identifier (e.g., a subset of bits included in an SCI-2 message). Additionally or alternatively, the network coded transmission may indicate a cast type (e.g., broadcast, multi-cast, or unicast) of each transmission, a feedback type (e.g., HARQ ACK feedback) of each transmission, a HARQ identifier of each transmission, or any combination thereof. In some examples, the network coded transmission may indicate a location of the source UE 315 (e.g., the UE 315-a) of the transmission, a communication range of the transmission, or both (e.g., as signaled in SCI-2). Additionally or alternatively, the network coded transmission may indicate a respective slot index in which each transmission was received at the network entity 306, such as an index relative to the network coded transmission. Additionally or alternatively, the network coded transmission may indicate a respective TB CRC, TB size, or both, of each transmission.

At 335, the network entity 306 may transmit an encoding indication of the network coded transmission. In some examples, the indication may be an explicit indication, for example in a field of control signaling, such as an SCI message (e.g., an SCI-1 or SCI-2 message), or in a MAC header or sub-header of the network coded transmission. In some examples, the indication may be an implicit indication. For example, the network entity 306 may indicate an SCI-2 format in an SCI-2 format indicator field in an SCI-1 message. The SCI-2 format may indicate that a transmission from the network entity 306 is the network coded transmission. Additionally or alternatively, the network entity 306 may include a source identifier in the network coded transmission. For example, the source identifier may be a device identifier associated with the network entity 306. The network entity 306 may indicate to the UEs 315 in a prior transmission that the device identifier is associated with network coded transmissions.

At 340, the network entity 306 may transmit the network coded transmission to the UEs 315, for example via one or more sidelink channels. At 345, the UE 315-b may identify the network coded transmission based on the encoding indication and decode the transmission requested for retransmission. For example, the UE 315-b may receive the network coded transmission, identify the transmission from the UE 315-a based on the one or more network coding parameters, and decode the transmission. The operations performed by the network entity 306 and the UEs 315 may support improvements to sidelink communications, among other benefits.

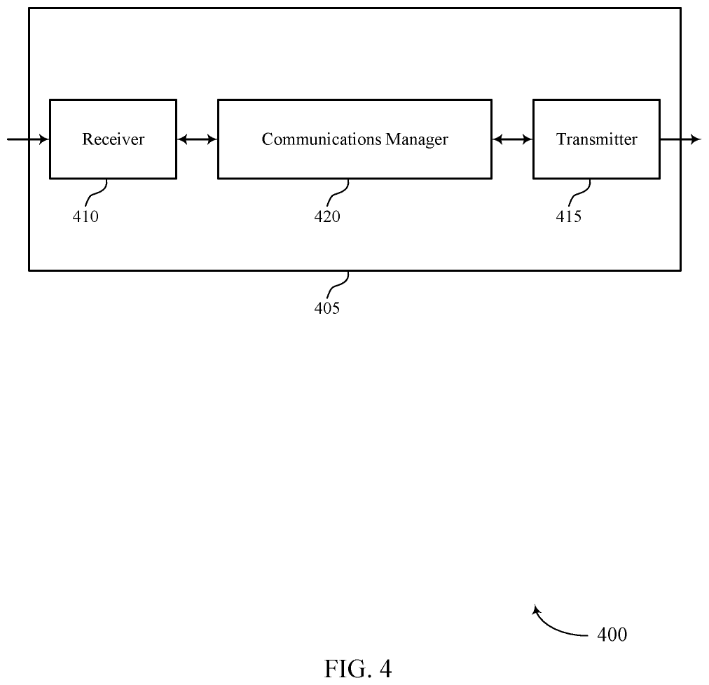

FIG. 4 shows a block diagram 400 of a device 405 that supports signaling details of network coded transmissions in accordance with aspects of the present disclosure. The device 405 may be an example of aspects of a network entity (e.g., a base station 105 or a UE 115) as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to signaling details of network coded transmissions). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to signaling details of network coded transmissions). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of signaling details of network coded transmissions as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a first device in accordance with examples as disclosed herein. For example, the communications manager 420 may be configured as or otherwise support a means for receiving, from a second device via a sidelink connection, a first transmission that includes an indication that the first transmission is to be encoded at the first device for retransmissions. The communications manager 420 may be configured as or otherwise support a means for transmitting, via the sidelink connection to a third device, a second transmission that is encoded based on the indication, the second transmission including at least the first transmission.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced processing, reduced power consumption, or more efficient utilization of communication resources based on broadcasting network coded transmissions.

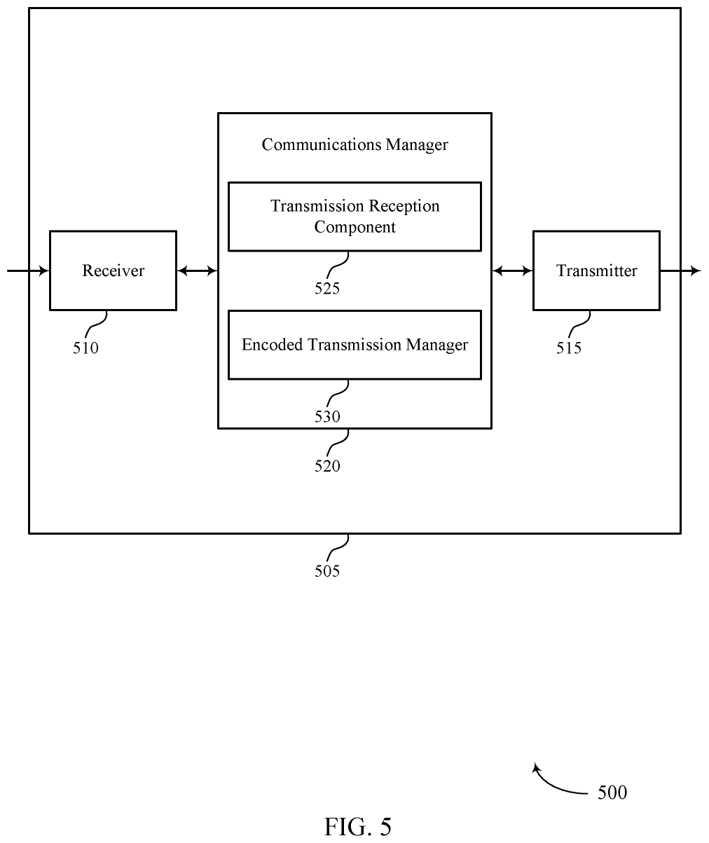

FIG. 5 shows a block diagram 500 of a device 505 that supports signaling details of network coded transmissions in accordance with aspects of the present disclosure. The device 505 may be an example of aspects of a device 405 or a network entity (e.g., a base station 105 or a UE 115) as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to signaling details of network coded transmissions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to signaling details of network coded transmissions). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of signaling details of network coded transmissions as described herein. For example, the communications manager 520 may include a transmission reception component 525 an encoded transmission manager 530, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first device in accordance with examples as disclosed herein. The transmission reception component 525 may be configured as or otherwise support a means for receiving, from a second device via a sidelink connection, a first transmission that includes an indication that the first transmission is to be encoded at the first device for retransmissions. The encoded transmission manager 530 may be configured as or otherwise support a means for transmitting, via the sidelink connection to a third device, a second transmission that is encoded based on the indication, the second transmission including at least the first transmission.

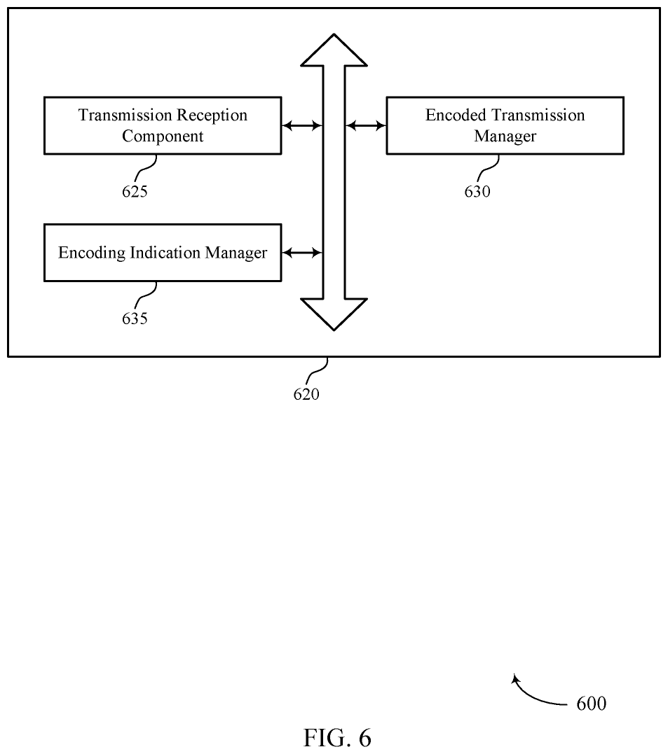

FIG. 6 shows a block diagram 600 of a communications manager 620 that supports signaling details of network coded transmissions in accordance with aspects of the present disclosure. The communications manager 620 may be an example of aspects of a communications manager 420, a communications manager 520, or both, as described herein. The communications manager 620, or various components thereof, may be an example of means for performing various aspects of signaling details of network coded transmissions as described herein. For example, the communications manager 620 may include a transmission reception component 625, an encoded transmission manager 630, an encoding indication manager 635, or any combination thereof. Each of these components may communicate, directly or indirectly, with one another (e.g., via one or more buses).

The communications manager 620 may support wireless communication at a first device in accordance with examples as disclosed herein. The transmission reception component 625 may be configured as or otherwise support a means for receiving, from a second device via a sidelink connection, a first transmission that includes an indication that the first transmission is to be encoded at the first device for retransmissions. The encoded transmission manager 630 may be configured as or otherwise support a means for transmitting, via the sidelink connection to a third device, a second transmission that is encoded based on the indication, the second transmission including at least the first transmission.

In some examples, the encoding indication manager 635 may be configured as or otherwise support a means for transmitting, in response to receiving the first transmission, an encoding indication in a sidelink control information message, a medium access control (MAC) header, a MAC sub-header, or any combination thereof, where the second transmission is encoded further based on the encoding indication.

In some examples, the encoding indication manager 635 may be configured as or otherwise support a means for transmitting, in a first sidelink control information message, a format indication for a second sidelink control information message, where the second transmission is encoded further based on the format indication.

In some examples, the encoding indication manager 635 may be configured as or otherwise support a means for transmitting signaling including a source identifier, where the second transmission is encoded further based on the source identifier.

In some examples, the source identifier includes a device identifier associated with the wireless device.

In some examples, the second transmission identifies a set of one or more transmissions encoded in the second transmission, the set of one or more transmissions including the first transmission.

In some examples, the second transmission identifies a first identifier and a second identifier associated with the first transmission, the first identifier corresponding to the second device and the second identifier corresponding to the third device.

In some examples, the second transmission includes a first set of one or more bits associated with the first identifier and a second set of one or more bits associated with the second identifier.

In some examples, the first set of one or more bits and the second set of one or more bits are included in a sidelink control information message associated with the first transmissions.

In some examples, the second transmission identifies one or more transmission parameters associated with the first transmission.

In some examples, the one or more transmission parameters include a cast type, a feedback type, a hybrid automatic repeat request identifier, a location of the first UE, a communication range, a slot index, an index relative to the second transmission, a transport block cyclic redundancy check value, a transport block size, or any combination thereof.

In some examples, the one or more transmission parameters are included in a sidelink control information message associated with the first transmission.

In some examples, the first device includes a roadside unit, a relay node, a user equipment, a base station, or any combination thereof.

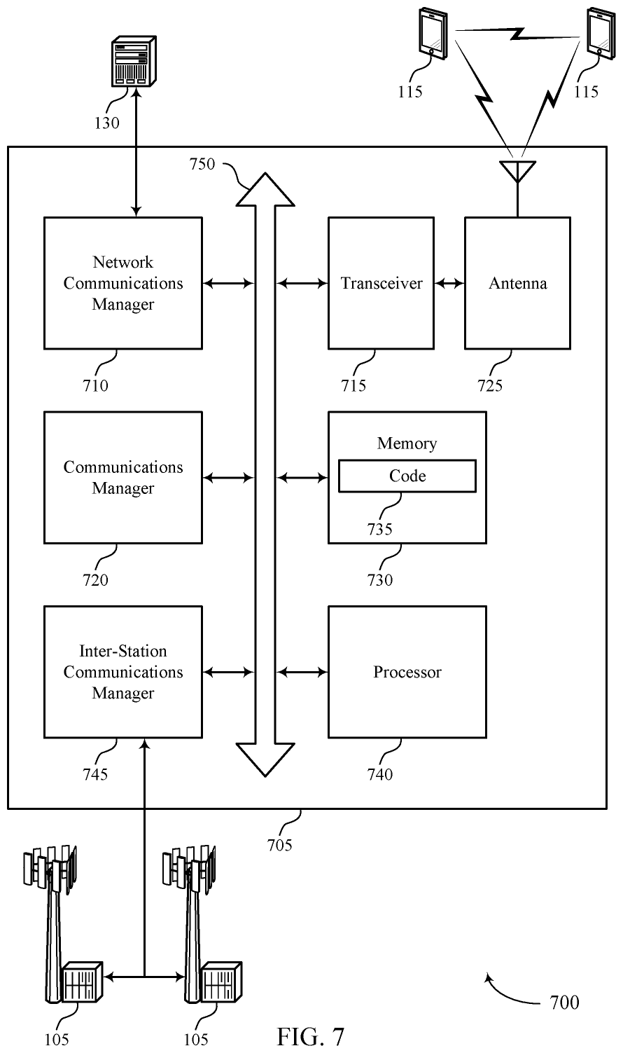

FIG. 7 shows a diagram of a system 700 including a device 705 that supports signaling details of network coded transmissions in accordance with aspects of the present disclosure. The device 705 may be an example of or include the components of a device 405, a device 505, or a network entity as described herein. The device 705 may include components for bi-directional voice and data communications including components for transmitting and receiving communications, such as a communications manager 720, a network communications manager 710, a transceiver 715, an antenna 725, a memory 730, code 735, a processor 740, and an inter-station communications manager 745. These components may be in electronic communication or otherwise coupled (e.g., operatively, communicatively, functionally, electronically, electrically) via one or more buses (e.g., a bus 750).

The network communications manager 710 may manage communications with a core network 130 (e.g., via one or more wired backhaul links). For example, the network communications manager 710 may manage the transfer of data communications for client devices, such as one or more UEs 115.

In some cases, the device 705 may include a single antenna 725. However, in some other cases the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting signaling details of network coded transmissions). For example, the device 705 or a component of the device 705 may include a processor 740 and memory 730 coupled to the processor 740, the processor 740 and memory 730 configured to perform various functions described herein.

The inter-station communications manager 745 may manage communications with other base stations 105, and may include a controller or scheduler for controlling communications with UEs 115 in cooperation with other base stations 105. For example, the inter-station communications manager 745 may coordinate scheduling for transmissions to UEs 115 for various interference mitigation techniques such as beamforming or joint transmission. In some examples, the inter-station communications manager 745 may provide an X2 interface within an LTE/LTE-A wireless communications network technology to provide communication between base stations 105.

The communications manager 720 may support wireless communication at a first device in accordance with examples as disclosed herein. For example, the communications manager 720 may be configured as or otherwise support a means for receiving, from a second device via a sidelink connection, a first transmission that includes an indication that the first transmission is to be encoded at the first device for retransmissions. The communications manager 720 may be configured as or otherwise support a means for transmitting, via the sidelink connection to a third device, a second transmission that is encoded based on the indication, the second transmission including at least the first transmission.

By including or configuring the communications manager 720 in accordance with examples as described herein, the device 705 may support techniques for improved communication reliability, reduced latency, reduced power consumption, more efficient utilization of communication resources, improved coordination between devices, or improved utilization of processing capability based on broadcasting network coded transmissions.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of signaling details of network coded transmissions as described herein, or the processor 740 and the memory 730 may be otherwise configured to perform or support such operations.

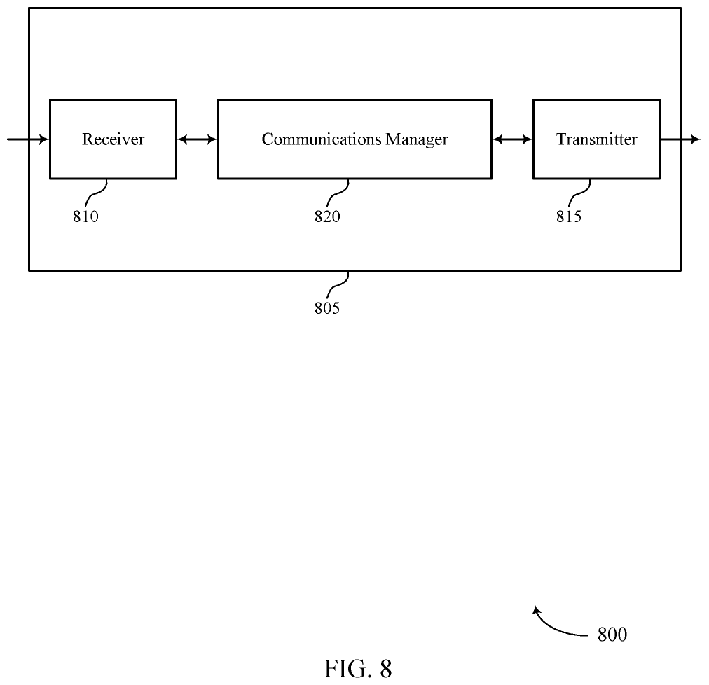

FIG. 8 shows a block diagram 800 of a device 805 that supports signaling details of network coded transmissions in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to signaling details of network coded transmissions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to signaling details of network coded transmissions). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of signaling details of network coded transmissions as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first device in accordance with examples as disclosed herein. For example, the communications manager 820 may be configured as or otherwise support a means for monitoring for a first transmission from a second device via a sidelink connection. The communications manager 820 may be configured as or otherwise support a means for receiving, from a third device, an encoding indication associated with the first transmission. The communications manager 820 may be configured as or otherwise support a means for receiving a second transmission from a third device. The communications manager 820 may be configured as or otherwise support a means for decoding the second transmission based on the encoding indication to obtain the first transmission.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, and more efficient utilization of communication resources based on receiving network coded transmissions.

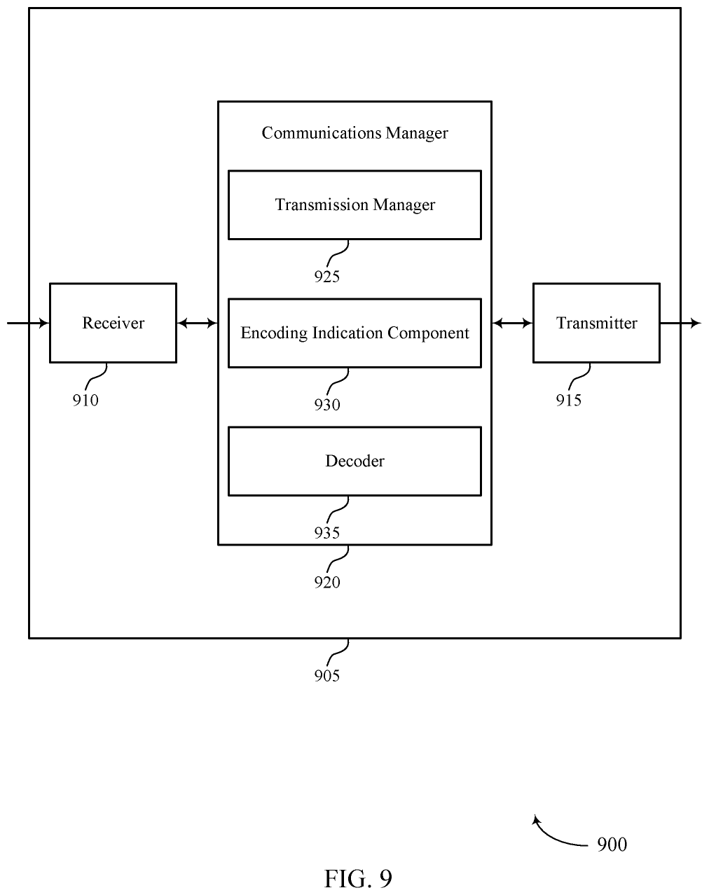

FIG. 9 shows a block diagram 900 of a device 905 that supports signaling details of network coded transmissions in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to signaling details of network coded transmissions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to signaling details of network coded transmissions). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of signaling details of network coded transmissions as described herein. For example, the communications manager 920 may include a transmission manager 925, an encoding indication component 930, a decoder 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a first device in accordance with examples as disclosed herein. The transmission manager 925 may be configured as or otherwise support a means for monitoring for a first transmission from a second device via a sidelink connection. The encoding indication component 930 may be configured as or otherwise support a means for receiving, from a third device, an encoding indication associated with the first transmission. The transmission manager 925 may be configured as or otherwise support a means for receiving a second transmission from a third device. The decoder 935 may be configured as or otherwise support a means for decoding the second transmission based on the encoding indication to obtain the first transmission.

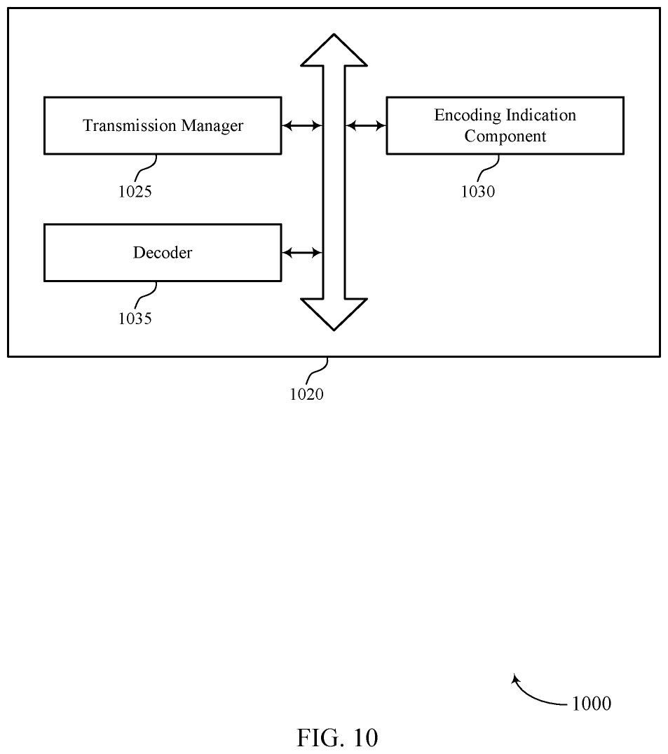

FIG. 10 shows a block diagram 1000 of a communications manager 1020 that supports signaling details of network coded transmissions in accordance with aspects of the present disclosure. The communications manager 1020 may be an example of aspects of a communications manager 820, a communications manager 920, or both, as described herein. The communications manager 1020, or various components thereof, may be an example of means for performing various aspects of signaling details of network coded transmissions as described herein. For example, the communications manager 1020 may include a transmission manager 1025, an encoding indication component 1030, a decoder 1035, or any combination thereof. Each of these components may communicate, directly or indirectly, with one another (e.g., via one or more buses).

The communications manager 1020 may support wireless communication at a first device in accordance with examples as disclosed herein. The transmission manager 1025 may be configured as or otherwise support a means for monitoring for a first transmission from a second device via a sidelink connection. The encoding indication component 1030 may be configured as or otherwise support a means for receiving, from a third device, an encoding indication associated with the first transmission. In some examples, the transmission manager 1025 may be configured as or otherwise support a means for receiving a second transmission from a third device. The decoder 1035 may be configured as or otherwise support a means for decoding the second transmission based on the encoding indication to obtain the first transmission.

In some examples, to support receiving the encoding indication, the encoding indication component 1030 may be configured as or otherwise support a means for receiving the encoding indication in a sidelink control information message, a medium access control (MAC) header, a MAC sub-header, or any combination thereof.

In some examples, to support receiving the encoding indication, the encoding indication component 1030 may be configured as or otherwise support a means for receiving, in a first sidelink control information message, a format indication for a second sidelink control information message, where the format indication includes the encoding indication.

In some examples, to support receiving the encoding indication, the encoding indication component 1030 may be configured as or otherwise support a means for receiving signaling including a source identifier, where the source identifier includes the encoding indication.

In some examples, the source identifier includes a device identifier associated with the wireless device.

In some examples, the second transmission identifies a set of one or more transmissions encoded in the second transmission, the set of one or more transmissions including the first transmission.

In some examples, the second transmission identifies a first identifier and a second identifier associated with the first transmission, the first identifier corresponding to the first device and the second identifier corresponding to the second device.

In some examples, the second transmission includes a first set of one or more bits associated with the first identifier and a second set of one or more bits associated with the second identifier.

In some examples, the first set of one or more bits and the second set of one or more bits are included in a sidelink control information message associated with the first transmission.

In some examples, the second transmission identifies one or more transmission parameters associated with the first transmission.

In some examples, the one or more transmission parameters include a cast type, a feedback type, a hybrid automatic repeat request identifier, a location of the second UE, a communication range, a slot index, an index relative to the second transmission, a transport block cyclic redundancy check value, a transport block size, or any combination thereof.

In some examples, the one or more transmission parameters are included in a sidelink control information message associated with the first transmission.

In some examples, the third device includes a roadside unit, a relay node, a user equipment, a base station, or any combination thereof.

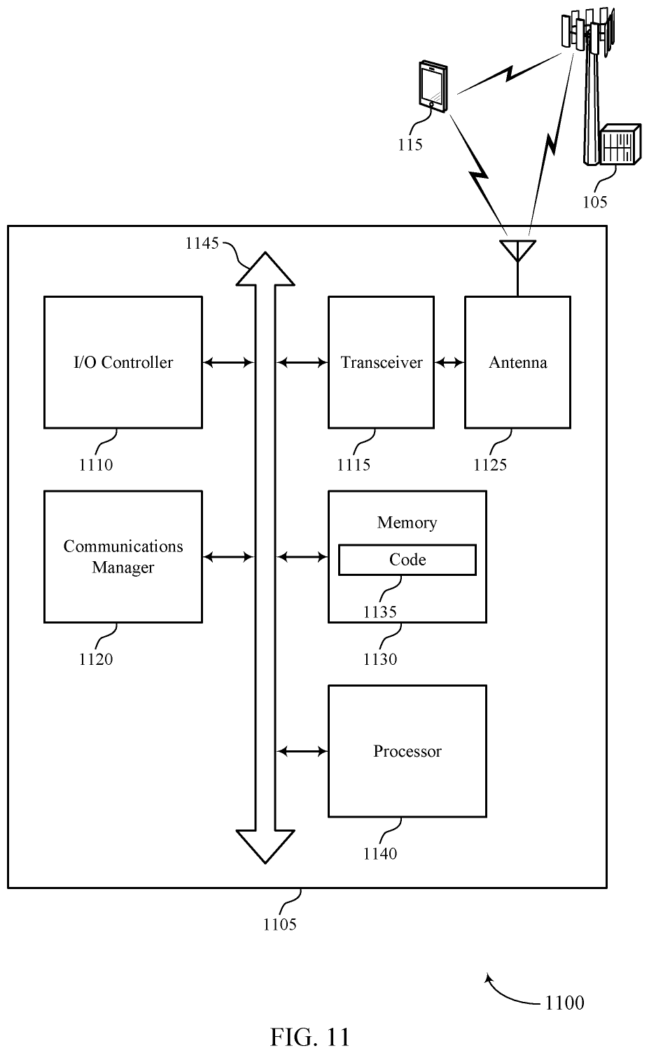

FIG. 11 shows a diagram of a system 1100 including a device 1105 that supports signaling details of network coded transmissions in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting signaling details of network coded transmissions). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at a first device in accordance with examples as disclosed herein. For example, the communications manager 1120 may be configured as or otherwise support a means for monitoring for a first transmission from a second device via a sidelink connection. The communications manager 1120 may be configured as or otherwise support a means for receiving, from a third device, an encoding indication associated with the first transmission. The communications manager 1120 may be configured as or otherwise support a means for receiving a second transmission from a third device. The communications manager 1120 may be configured as or otherwise support a means for decoding the second transmission based on the encoding indication to obtain the first transmission.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, and improved utilization of processing capability based on receiving network coded transmissions.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of signaling details of network coded transmissions as described herein, or the processor 1140 and the memory 1130 may be otherwise configured to perform or support such operations.

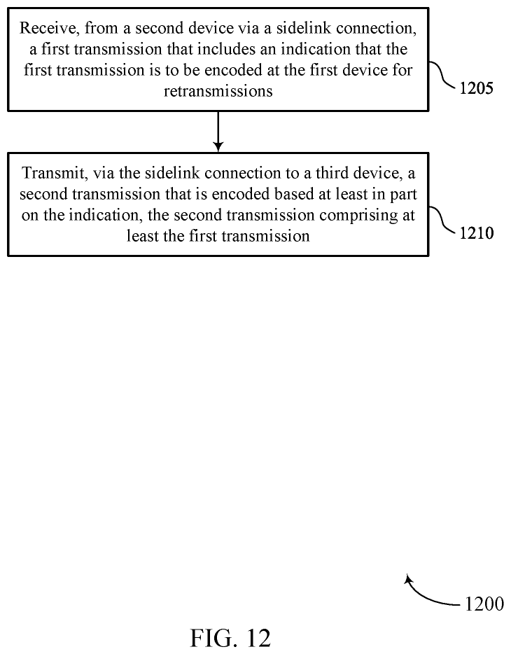

FIG. 12 shows a flowchart illustrating a method 1200 that supports signaling details of network coded transmissions in accordance with aspects of the present disclosure. The operations of the method 1200 may be implemented by a network entity or its components as described herein. For example, the operations of the method 1200 may be performed by a network entity as described with reference to FIGS. 1 through 7. In some examples, a network entity may execute a set of instructions to control the functional elements of the network entity to perform the described functions. Additionally or alternatively, the network entity may perform aspects of the described functions using special-purpose hardware.

At 1205, the method may include receiving, from a second device via a sidelink connection, a first transmission that includes an indication that the first transmission is to be encoded at the first device for retransmissions. The operations of 1205 may be performed in accordance with examples as disclosed herein. In some examples, aspects of the operations of 1205 may be performed by a transmission reception component 625 as described with reference to FIG. 6.

At 1210, the method may include transmitting, via the sidelink connection to a third device, a second transmission that is encoded based on the indication, the second transmission including at least the first transmission. The operations of 1210 may be performed in accordance with examples as disclosed herein. In some examples, aspects of the operations of 1210 may be performed by an encoded transmission manager 630 as described with reference to FIG. 6.

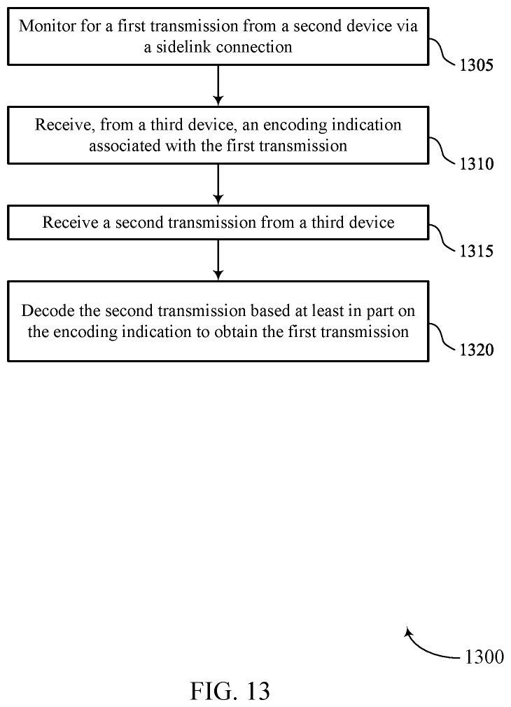

FIG. 13 shows a flowchart illustrating a method 1300 that supports signaling details of network coded transmissions in accordance with aspects of the present disclosure. The operations of the method 1300 may be implemented by a UE or its components as described herein. For example, the operations of the method 1300 may be performed by a UE 115 as described with reference to FIGS. 1 through 3 and 8 through 11. In some examples, a UE may execute a set of instructions to control the functional elements of the UE to perform the described functions. Additionally or alternatively, the UE may perform aspects of the described functions using special-purpose hardware.

At 1305, the method may include monitoring for a first transmission from a second device via a sidelink connection. The operations of 1305 may be performed in accordance with examples as disclosed herein. In some examples, aspects of the operations of 1305 may be performed by a transmission manager 1025 as described with reference to FIG. 10.

At 1310, the method may include receiving, from a third device, an encoding indication associated with the first transmission. The operations of 1310 may be performed in accordance with examples as disclosed herein. In some examples, aspects of the operations of 1310 may be performed by an encoding indication component 1030 as described with reference to FIG. 10.

At 1315, the method may include receiving a second transmission from a third device. The operations of 1315 may be performed in accordance with examples as disclosed herein. In some examples, aspects of the operations of 1315 may be performed by a transmission manager 1025 as described with reference to FIG. 10.

At 1320, the method may include decoding the second transmission based on the encoding indication to obtain the first transmission. The operations of 1320 may be performed in accordance with examples as disclosed herein. In some examples, aspects of the operations of 1320 may be performed by a decoder 1035 as described with reference to FIG. 10.

The following provides an overview of aspects of the present disclosure:

Aspect 1: A method for wireless communication at a first device, comprising: receiving, from a second device via a sidelink connection, a first transmission that includes an indication that the first transmission is to be encoded at the first device for retransmissions; and transmitting, via the sidelink connection to a third device, a second transmission that is encoded based at least in part on the indication, the second transmission comprising at least the first transmission.

Aspect 2: The method of aspect 1, further comprising: transmitting, in response to receiving the first transmission, an encoding indication in a sidelink control information message, a medium access control (MAC) header, a MAC sub-header, or any combination thereof, wherein the second transmission is encoded further based at least in part on the encoding indication.

Aspect 3: The method of any of aspects 1 through 2, further comprising: transmitting, in a first sidelink control information message, a format indication for a second sidelink control information message, wherein the second transmission is encoded further based at least in part on the format indication.

Aspect 4: The method of any of aspects 1 through 3, further comprising: transmitting signaling comprising a source identifier, wherein the second transmission is encoded further based at least in part on the source identifier.

Aspect 5: The method of aspect 4, wherein the source identifier comprises a device identifier associated with the wireless device.

Aspect 6: The method of any of aspects 1 through 5, wherein the second transmission identifies a set of one or more transmissions encoded in the second transmission, the set of one or more transmissions including the first transmission.

Aspect 7: The method of any of aspects 1 through 6, wherein the second transmission identifies a first identifier and a second identifier associated with the first transmission, the first identifier corresponding to the second device and the second identifier corresponding to the third device.

Aspect 8: The method of aspect 7, wherein the second transmission comprises a first set of one or more bits associated with the first identifier and a second set of one or more bits associated with the second identifier.

Aspect 9: The method of aspect 8, wherein the first set of one or more bits and the second set of one or more bits are included in a sidelink control information message associated with the first transmissions.

Aspect 10: The method of any of aspects 1 through 9, wherein the second transmission identifies one or more transmission parameters associated with the first transmission.

Aspect 11: The method of aspect 10, wherein the one or more transmission parameters comprise a cast type, a feedback type, a hybrid automatic repeat request identifier, a location of the first UE, a communication range, a slot index, an index relative to the second transmission, a transport block cyclic redundancy check value, a transport block size, or any combination thereof.

Aspect 12: The method of any of aspects 10 through 11, wherein the one or more transmission parameters are included in a sidelink control information message associated with the first transmission.

Aspect 13: The method of any of aspects 1 through 12, wherein the first device comprises a roadside unit, a relay node, a user equipment, a base station, or any combination thereof.

Aspect 14: A method for wireless communication at a first device, comprising: monitoring for a first transmission from a second device via a sidelink connection; receiving, from a third device, an encoding indication associated with the first transmission; receiving a second transmission from a third device; and decoding the second transmission based at least in part on the encoding indication to obtain the first transmission.

Aspect 15: The method of aspect 14, wherein receiving the encoding indication comprises: receiving the encoding indication in a sidelink control information message, a medium access control (MAC) header, a MAC sub-header, or any combination thereof.

Aspect 16: The method of any of aspects 14 through 15, wherein receiving the encoding indication comprises: receiving, in a first sidelink control information message, a format indication for a second sidelink control information message, wherein the format indication comprises the encoding indication.

Aspect 17: The method of any of aspects 14 through 16, wherein receiving the encoding indication comprises: receiving signaling comprising a source identifier, wherein the source identifier comprises the encoding indication.

Aspect 18: The method of aspect 17, wherein the source identifier comprises a device identifier associated with the wireless device.

Aspect 19: The method of any of aspects 14 through 18, wherein the second transmission identifies a set of one or more transmissions encoded in the second transmission, the set of one or more transmissions including the first transmission.

Aspect 20: The method of any of aspects 14 through 19, wherein the second transmission identifies a first identifier and a second identifier associated with the first transmission, the first identifier corresponding to the first device and the second identifier corresponding to the second device.

Aspect 21: The method of aspect 20, wherein the second transmission comprises a first set of one or more bits associated with the first identifier and a second set of one or more bits associated with the second identifier.

Aspect 22: The method of aspect 21, wherein the first set of one or more bits and the second set of one or more bits are included in a sidelink control information message associated with the first transmission.

Aspect 23: The method of any of aspects 14 through 22, wherein the second transmission identifies one or more transmission parameters associated with the first transmission.

Aspect 24: The method of aspect 23, wherein the one or more transmission parameters comprise a cast type, a feedback type, a hybrid automatic repeat request identifier, a location of the second UE, a communication range, a slot index, an index relative to the second transmission, a transport block cyclic redundancy check value, a transport block size, or any combination thereof.

Aspect 25: The method of any of aspects 23 through 24, wherein the one or more transmission parameters are included in a sidelink control information message associated with the first transmission.

Aspect 26: The method of any of aspects 14 through 25, wherein the third device comprises a roadside unit, a relay node, a user equipment, a base station, or any combination thereof.

Aspect 27: An apparatus for wireless communication at a first device, comprising a processor; memory coupled with the processor; and instructions stored in the memory and executable by the processor to cause the apparatus to perform a method of any of aspects 1 through 13.

Aspect 28: An apparatus for wireless communication at a first device, comprising at least one means for performing a method of any of aspects 1 through 13.

Aspect 29: A non-transitory computer-readable medium storing code for wireless communication at a first device, the code comprising instructions executable by a processor to perform a method of any of aspects 1 through 13.

Aspect 30: An apparatus for wireless communication at a first device, comprising a processor; memory coupled with the processor; and instructions stored in the memory and executable by the processor to cause the apparatus to perform a method of any of aspects 14 through 26.

Aspect 31: An apparatus for wireless communication at a first device, comprising at least one means for performing a method of any of aspects 14 through 26.

Aspect 32: A non-transitory computer-readable medium storing code for wireless communication at a first device, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first device, comprising:
a processor;
memory coupled with the processor; and
instructions stored in the memory and executable by the processor to cause the apparatus to:
receive, from a second device via a sidelink connection, a first transmission that includes an indication that the first transmission is to be encoded at the first device for retransmissions; and
transmit, via the sidelink connection to a third device, a second transmission that is encoded based at least in part on the indication, the second transmission comprising at least the first transmission.

2. The apparatus of claim 1, wherein the instructions are further executable by the processor to cause the apparatus to:
transmit, in response to receiving the first transmission, an encoding indication in a sidelink control information message, a medium access control (MAC) header, a MAC sub-header, or any combination thereof, wherein the second transmission is encoded further based at least in part on the encoding indication.

3. The apparatus of claim 1, wherein the instructions are further executable by the processor to cause the apparatus to:
transmit, in a first sidelink control information message, a format indication for a second sidelink control information message, wherein the second transmission is encoded further based at least in part on the format indication.

4. The apparatus of claim 1, wherein the instructions are further executable by the processor to cause the apparatus to:
transmit signaling comprising a source identifier, wherein the second transmission is encoded further based at least in part on the source identifier.

5. The apparatus of claim 4, wherein the source identifier comprises a device identifier associated with the wireless device.

6. The apparatus of claim 1, wherein the second transmission identifies a set of one or more transmissions encoded in the second transmission, the set of one or more transmissions including the first transmission.

7. The apparatus of claim 1, wherein the second transmission identifies a first identifier and a second identifier associated with the first transmission, the first identifier corresponding to the second device and the second identifier corresponding to the third device.

8. The apparatus of claim 7, wherein the second transmission comprises a first set of one or more bits associated with the first identifier and a second set of one or more bits associated with the second identifier.

9. The apparatus of claim 8, wherein the first set of one or more bits and the second set of one or more bits are included in a sidelink control information message associated with the first transmissions.

10. The apparatus of claim 1, wherein the second transmission identifies one or more transmission parameters associated with the first transmission.

11. The apparatus of claim 10, wherein the one or more transmission parameters comprise a cast type, a feedback type, a hybrid automatic repeat request identifier, a location of the first UE, a communication range, a slot index, an index relative to the second transmission, a transport block cyclic redundancy check value, a transport block size, or any combination thereof.

12. The apparatus of claim 10, wherein the one or more transmission parameters are included in a sidelink control information message associated with the first transmission.

13. The apparatus of claim 1, wherein the first device comprises a roadside unit, a relay node, a user equipment, a base station, or any combination thereof.

14. An apparatus for wireless communication at a first device, comprising:
a processor;
memory coupled with the processor; and
instructions stored in the memory and executable by the processor to cause the apparatus to:
monitor for a first transmission from a second device via a sidelink connection;
receive, from a third device, an encoding indication associated with the first transmission;
receive a second transmission from a third device; and
decode the second transmission based at least in part on the encoding indication to obtain the first transmission.

15. The apparatus of claim 14, wherein the instructions to receive the encoding indication are executable by the processor to cause the apparatus to:
receive the encoding indication in a sidelink control information message, a medium access control (MAC) header, a MAC sub-header, or any combination thereof.

16. The apparatus of claim 14, wherein the instructions to receive the encoding indication are executable by the processor to cause the apparatus to:
receive, in a first sidelink control information message, a format indication for a second sidelink control information message, wherein the format indication comprises the encoding indication.

17. The apparatus of claim 14, wherein the instructions to receive the encoding indication are executable by the processor to cause the apparatus to:
receive signaling comprising a source identifier, wherein the source identifier comprises the encoding indication.

18. The apparatus of claim 17, wherein the source identifier comprises a device identifier associated with the wireless device.

19. The apparatus of claim 14, wherein the second transmission identifies a set of one or more transmissions encoded in the second transmission, the set of one or more transmissions including the first transmission.

20. The apparatus of claim 14, wherein the second transmission identifies a first identifier and a second identifier associated with the first transmission, the first identifier corresponding to the first device and the second identifier corresponding to the second device.

21. The apparatus of claim 20, wherein the second transmission comprises a first set of one or more bits associated with the first identifier and a second set of one or more bits associated with the second identifier.

22. The apparatus of claim 21, wherein the first set of one or more bits and the second set of one or more bits are included in a sidelink control information message associated with the first transmission.

23. The apparatus of claim 14, wherein the second transmission identifies one or more transmission parameters associated with the first transmission.

24. The apparatus of claim 23, wherein the one or more transmission parameters comprise a cast type, a feedback type, a hybrid automatic repeat request identifier, a location of the second UE, a communication range, a slot index, an index relative to the second transmission, a transport block cyclic redundancy check value, a transport block size, or any combination thereof.

25. The apparatus of claim 23, wherein the one or more transmission parameters are included in a sidelink control information message associated with the first transmission.

26. The apparatus of claim 14, wherein the third device comprises a roadside unit, a relay node, a user equipment, a base station, or any combination thereof.

27. A method for wireless communication at a first device, comprising:
receiving, from a second device via a sidelink connection, a first transmission that includes an indication that the first transmission is to be encoded at the first device for retransmissions; and
transmitting, via the sidelink connection to a third device, a second transmission that is encoded based at least in part on the indication, the second transmission comprising at least the first transmission.

28. The method of claim 27, further comprising:
transmitting, in response to receiving the first transmission, an encoding indication in a sidelink control information message, a medium access control (MAC) header, a MAC sub-header, or any combination thereof, wherein the second transmission is encoded further based at least in part on the encoding indication.

29. The method of claim 27, further comprising:
transmitting, in a first sidelink control information message, a format indication for a second sidelink control information message, wherein the second transmission is encoded further based at least in part on the format indication.

30. A method for wireless communication at a first device, comprising:
monitoring for a first transmission from a second device via a sidelink connection;
receiving, from a third device, an encoding indication associated with the first transmission;
receiving a second transmission from a third device; and
decoding the second transmission based at least in part on the encoding indication to obtain the first transmission.
